(19) United States
(12) Patent Application Publication
(10) Pub. No.: US 2010/0052491 A1
(43) Pub. Date: Mar. 4, 2010

(54) SHELF, IN PARTICULAR FOR REFRIGERATED INSTALLATIONS

(75) Inventor: Francois Vardon, Queretaro (MX)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/552,309

(22) Filed: Sep. 2, 2009

(30) Foreign Application Priority Data
Sep. 3, 2008 (FR) 08 55905

(51) Int. Cl. F25D 23/08; A47F 5/00; B23P 25/00

(52) U.S. Cl. 312/408; 211/134; 29/458

(57) ABSTRACT

A shelf for a furniture item, particularly for a refrigerator or similar item, including a panel intended to accommodate articles and an added plastic surround. The shelf includes between the panel and the surround, at least one added elastic seal.

### BACKGROUND OF THE INVENTION

1. Field of the Invention

The present invention relates to a shelf or tray for supporting articles, intended to be attached or mounted, advantageously in a removable manner, in the chassis of a furniture item. In particular, it relates to a shelf capable of being used in refrigerated compartments (such as refrigerated cabinets, refrigeration apparatus, refrigerators) for the support of articles, particularly foodstuffs.

2. Discussion of the Background

These shelves usually include solid plates (or panels) made of mineral glass or organic material (polycarbonate, polymethyl methacrylate, etc.), which are monolithic or laminated, these plates being provided with a total or partial surround made of plastic, this surround allowing to prevent risks of wounds on the sharp edges of the plates and/or to reinforce the said plates.

A problem occurs with these shelves when liquid has been spilt by accident, for example because a receptacle has fallen or has broken, and it is necessary to prevent this liquid from dripping and other consequences which could be prejudicial to the conservation of foodstuffs in good hygienic conditions.

In order to overcome these problems, it is known practice, as described for example in patent U.S. Pat. No. 5,362,145, to form a rim by encapsulation around the peripheral rim (or edge) of the panel, this direct moulding of the rim onto the panel providing a better seal between the rim and the panel and preventing the spilling or infiltration of a spilt product, the rim also forming a barrier keeping the spilt product on the panel. The production of shelves according to this solution however requires special installations, may be fairly complex and is not always economical or satisfactory for ensuring a sufficient and durable seal.

There are other methods for assembling the plastic surround on the panel, in particular by adding a surround to the panel, for example by bonding, clipping or interlocking sides of the surround, the imperviousness being able, as necessary, to be enhanced by the presence of a seal (such as a seal of adhesive), the positioning of which is usually awkward, the seal being able to move or be damaged during the assembly or the presence of the seal being able to make assembly more awkward or complicated.

### SUMMARY OF THE INVENTION

Assembling the plastic surround to the panel by adding a surround to the panel may also be carried out advantageously by retraction of the surround just after moulding, the panel being in this case assembled to the surround on coming out of the mould before the complete retraction of the plastic, this method of assembly being particularly simple and effective.

The present invention relates in particular to these shelves for which the plastic surround fits tightly around the edges of the panel, particularly by retraction, such shelves in particular being described by the Applicant Company in the PCT international applications WO 02/076268 A1 and WO 2006 059038 A1. Usually the surrounds of these shelves comprise a rim that is applied to the whole periphery of the top face of the panel (considered in the position of use). If liquid flows from foodstuffs placed on the shelf, it is particularly held by the vertical end border of this rim. The imperviousness of these shelves may also be enhanced, if necessary, by the addition of an adhesive at the border of a face of the panel, before assembly with the plastic surround, the adhesive finally being masked by the plastic surround and/or by a decorative element such as an enamel. The adhesive must however be positioned precisely in order to avoid overflows and/or to avoid damaging the appearance of the shelf.

The object of the present invention is to propose a simple, economic and effective solution to enhance the imperviousness of the shelves, particularly to prevent liquid from dripping beneath the shelves, the object of the invention being in particular to propose new shelves, suitable for refrigerators or similar elements, enhanced with respect to the existing shelves, in particular both very simple to produce and to use and at the same time being perfectly impervious (watertight).

This object is achieved in the present invention, proposing in particular an enhanced shelf and a method of producing the shelf. The present invention therefore relates in the first place to a shelf for a furniture item, particularly for a refrigerator or similar item, comprising a panel intended to accommodate articles and an added plastic surround (or frame), the shelf being characterized in that it comprises, between the panel and the surround, at least one added elastic seal.

The present invention also relates to a method for producing the shelf according to which the plastic surround is hot-formed (by moulding) separately from the panel, the panel and the plastic surround being assembled before the complete retraction of the plastic, the method being characterized in that at least one added elastic seal is mounted (assembled) on the panel (in particular on its periphery, on its edge) before it is (they are) assembled with the plastic surround and/or is interposed between the panel and the surround before the complete retraction of the plastic.

“Added surround” means that the plastic surround is formed (it is given its form) separately from the panel, and not directly around the panel. “Added (or preformed) seal” also means that the seal is formed separately from the panel and from the surround and not directly on the panel or on the surround.

The seal can be advantageously a closed seal, that is to say that it is in a single continuous piece closed on itself, for example in the form of a closed band or ring, being able to be circular (or annular or of oval shape) or of rectangular or square shape, etc.). Preferably, the shape of the seal at rest (not stretched) corresponds approximately to that of the panel of the shelf. Also preferably, the seal at rest can delimit a surface area slightly smaller than that of the panel, in particular a surface area (or respectively a length or perimeter) that is in the order of 10 to 20% smaller than that of the panel (respectively than the perimeter of the panel).

The seal can be an elastic seal, the seal being able to stretch in order to allow it to be placed on the panel. Its rate of elongation (or its stretching capacity) depends in particular on its size at rest, compared to the size of the panel, and is usually of the order of at least 10 to (at least) 20% (the deformation, which is reversible, being able to be much greater than 20%, depending on the embodiment) so as to achieve the dimensions of the panel and to be able to be easily manipulated when it is put in place.

Also preferably, the seal can have a shape making it simple to install by straddling (overlapping) the edge or rim of the panel, the shape also allowing a better contact when it is mechanically squashed between the panel and the plastic surround. In particular and advantageously, it can have a section (cross section, perpendicular to the axis of the seal), at least approximately or globally, which is U-shaped (this section being generally constant or approximately constant) so as to straddle the edge of the panel, the dimensions of this section, such as the distance apart of the branches of the U, advantageously coinciding with those of the edge of the panel. In another embodiment, the seal may also have an L-shaped section so as not to be exposed on one face where it might be visible, as illustrated below, or even another section having at least one portion or branch straddling the edge of the panel, such as an M-shaped section, etc.

The seal may be made of various materials that are impervious, in particular to liquids, the material(s) forming the seal preferably also allowing contact with food; the seal may also, if necessary, be self-adhesive and/or hollow, etc. Advantageously, the seal and/or the material(s) forming the seal also make it possible to compensate for the respective expansions of the panel and of the plastic due to the changes of temperature during transport or use of the shelf and/or to compensate for the tolerances of the panel (such as the differences in dimensions of the plates relative to the mechanical fabrications of the said plates).

As explained below, this seal is usually placed on the edge of the panel (advantageously straddling the edge) by stretching the seal when it is installed, and then adapts to the contours of the panel when the seal is released. Thus positioned on the periphery of the panel, the seal remains in place during the handling of the panel thus provided, then during assembly of the unit formed by the panel and the seal with the plastic surround; in particular, when the panel provided with the seal is placed inside the plastic surround that has just been taken out of the mould and when the latter is secured with the panel-seal assembly by retraction, the seal remains in place and is even more greatly compressed on the periphery of the panel by the radial/lateral pressure (or compression force) exerted by the retracted plastic of the surround, thereby ensuring excellent imperviousness.

The shelf according to the invention is, as it appears, particularly simple to design and assembly, while having good imperviousness as is sought in the present invention.

The shelf is thus obtained by starting with separate elements, as already explained, namely at least one panel, one plastic surround and one seal (as already described), each formed separately.

The panel (or tray or plate) can be, for its part, generally rectangular, rigid, and has an approximately flat surface for the support of articles (upper face, in the position of use) and is not very thick relative to its surface area. It is usually formed in one piece (monolithic) but may if necessary be more complex (it may, for example, have a laminated structure). It may be opaque or translucent but is preferably at least partially transparent, for aesthetic and practical reasons; it may also be provided with a decorative or functional pattern or patterns, or layer or layers, (for example in enamel or ink) on one or more of its faces.

The panel is usually glass-based and/or made of plastic material(s) (such as polycarbonate and/or polymethyl methacrylate). Preferably, it is a panel (or sheet) of glass, a material that is advantageous in terms of hygiene, rigidity, durability, etc. In the case of a monolithic panel, this glass is usually (for safety reasons) tempered (toughened, dip-coated). The panel is usually flat and solid, but may if necessary comprise one or more reliefs and/or have undergone one or more surface treatments such as sandblasting, striation, etc.

The plastic surround (structure, support, frame) for its part allows jointly the support of the panel and the coating of its sharp edges for a more comfortable and secure handling of the shelf. It may have a thickness slightly exceeding that of the panel or may be greater, for example on portions of its periphery, one or more walls of the surround being able to exceed the plane of the panel. It generally runs around the panel over the whole of its periphery, in particular on its edge (or, in other words, its thickness or its edges if each of the sides is considered separately) and, if necessary, over at least a portion of at least one of the faces of the panel (for example the top face over a width of a few millimetres on some or all of its periphery and/or it may have protruding portions on its lower face, particularly for the support of the panel). Moreover, the walls may run round only a portion of the edge, a wall being able, for example, to have openings over a portion of the edge on at least one of the sides.

The rims or walls of the plastic surround may be straight and uniform or of a more complex shape, particularly they may have peripheral portions or extensions for functional or aesthetic purposes. For example, the front rim (or the side intended to remain free in the position of use) may form a handle for manipulating the shelf and/or the lateral rims and/or the rear rim (in the position of use in a furniture item) may be suitable for interacting with the chassis of the furniture item (which usually supports racks or slides for supporting the shelves), for example they may support protrusions (wings, nipples etc.) capable of sliding between rails or on supports arranged in the lateral walls of a furniture item, etc. Elements or shapes (such as ribs) for reinforcement, for attachment, etc., which may be plastic and/or if necessary metal, may also be added or provided in the plastic surround.

The surround is generally in the form of a frame offering in particular one or more bearing surfaces for the support of the panel and/or on which members (or parts) for maintaining of the panel are added. Preferably, these bearing surfaces and/or these maintaining members are placed on a bottom part or face (in the position of use in the shelf obtained) of the surround.

When the frame offers one or more bearing surfaces, these surfaces may, for example, be in the form of tongues or nipples protruding relative to the frame, on the bottom face in the position of use and around the central opening of the frame where the panel is to be placed; there may also be a continuous bearing surface in the form of a frame supporting the panel at its periphery and/or if necessary in other locations or else the plastic structure may also be solid and support the panel over the whole of its bottom face.

When the members for retaining the panel are added and associated with/secured to the surround, these members may have the shape of parts comprising a portion that is applied against a peripheral region of the bottom face (in the position of use) of the panel and comprising at least one attachment means complementary to a means supported by the surround (usually supported by its bottom face); and/or these members may take the form of limit stops (“cavaliers”) capable of straddling (overlapping) at least one protrusion or rib of the frame (running along the panel and protruding from the latter), and of coming to rest, in the pushed-in position, against the panel; and/or these members may be parts capable of being inserted laterally into one or more holes made in at least one protrusion or rib of the frame (running along the panel and protruding from the latter), then of snap-fitting or hooking onto or behind the border wall of the hole or holes, then, in the snapped-in or hooked position, resting against the panel; etc.

This embodiment, with added maintaining members, can be particularly advantageous because the insertion of the panel and of the seal (in particular of the panel provided with the seal) into the surround may be carried out without difficulty (and therefore be automated) because of the absence on the surround (as moulded and ready for assembly in particular) of bearing surfaces protruding into the space intended for the panel and therefore hampering its insertion, the maintaining of the panel beneath its bottom face being, specifically, achieved by the maintaining members that are added once the panel has been inserted into the surround. It is possible to use one or more maintaining members, these members being able to be distributed over the periphery of the surround in various ways (in particular placed in locations that are strong and/or easy to mask) and being able to have an identical or different shape depending on the locations. Members may, if necessary, be coupled (particularly when they are of small size), for example joined together by a rod, by two or more, in totality or for some of them, in order to make them easier to install simultaneously if required; and/or one or more maintaining members may have the shape of a frame, of a portion of a frame or of a strip intended to be pressed along a corresponding portion of the surround and comprising for example attachment members distributed along the latter.

The maintaining members are therefore advantageously added to the surround after insertion of the panel and of the seal (or assembly of the panel and of the seal with the surround), once the structure has been entirely retracted and/or cooled or, if necessary, before (for example, a member may pierce a hole in a rib of the surround while the latter is still hot).

If necessary, the panel may be provided with an enamelled border (particularly on the bottom face) making it possible to mask the seal and the maintaining member(s) and/or bearing surfaces of the surround, the said maintaining members and/or protruding portions being able, for their part, also to mask (on the other face of the shelf) at least partly the seal and/or immobilize it on its apparent rim if necessary.

In addition to the panel, the surround, the seal and any possible decorations, the shelf according to the invention may also have other elements and/or particular features; for example the plastic surround may have or interact with lighting means (preferably of low voltage) and/or a surface (for example a bottom surface) of the panel may be treated or machined, for example sandblasted or grooved, in order to amplify the lighting effect by refraction of the light beam emitted by a light source. It is also not out of the question that the shelf also comprises an adhesive, deposited preferably along the periphery of the structure, and/or one or more beads of insulation injected for example onto the plastic surround before complete retraction, for example made of foam or hot melt adhesive in order to further improve the imperviousness of the assembly.

The shelf is capable of being used in a furniture item, such as a refrigerated cabinet, refrigeration apparatus or refrigerator, a further subject of the invention being the furniture item comprising at least one shelf as defined above.

One embodiment of the invention also relates to a method in which the adaptation of the surround to the contours of the panel (or the securing of the surround and of the panel) is obtained by retraction of the plastic (or of the said surround), the elastic seal being mounted on the panel before they are assembled (the panel and the seal) with the plastic surround and/or interposed between the panel and the surround before the complete retraction of the plastic.

According to a preferred embodiment, this method takes place according to the following steps:
the seal is stretched and is positioned on the edge of the panel around the latter (the seal then being released and remaining positioned on the periphery of the panel);
the surround, in the form of a frame, coming out of the moulding still in the hot state, is placed on a support, the frame being placed on its face which will be the top face in the position of use;
the panel provided with the seal is inserted into the frame when still in the hot state;
the frame is allowed to retract.

If the surround comprises one or more bearing surfaces, for example in the form of tongues or nipples, the insertion of the panel provided with the seal is carried out by inserting the panel, usually by force, between the tongues or nipples and the rest of the surround, before complete retraction of the surround.

If one or more added members, for retaining the panel, are attached to the surround, these members may be attached to the surround still in the hot state and before complete retraction and/or once the frame has retracted and/or cooled.

In the preferred embodiment above, the panel and the seal are inserted from the side of the surround forming, in the position of use, the bottom face of the shelf (the surround in this case being, if necessary, turned over during the assembly or, if necessary, coming out of the mould in the turned-over position). In another embodiment, depending on the surround, the panel and the seal may be inserted into (through the) top face of the surround, and/or (more or less) slid through one side, etc.

The surround is moulded, for example, by injecting a plastic, previously heated and melted, into a closed mould or a press (the plastic being in particular polypropylene, if necessary laden with talc to improve its mechanical strength, or acrylonitrile butadiene styrene (ABS), etc.), the plastic being chosen according to the characteristics, particularly strength, that are sought for the structure, but also according to its ability to retract as sought in the invention. Once moulded, the material cools and solidifies, initially in the mould (or the press) in order to give a semi-finished product that can be extracted from the mould without generally losing its shape, then out of the mould, the retraction phenomenon taking place mainly after the opening of the mould and all the more so after extraction from the mould (the dimensions reducing but the shape remaining substantially the same).

It should be noted in particular that the plastic surround may also be produced via a technique called “air moulding” (or gas-assisted plastic injection), this technique making it possible to obtain a shelf having good strength and rigidity with less material than a conventional moulding. This technique includes inserting a pressurized inert gas (for example nitrogen) during moulding into the melted plastic, after the mould cavity has been partially filled, in order to create, inside the moulded part, zones of reinforced thickness and empty zones. Air moulding makes it possible, for example, to create reinforcements (extra thicknesses, ribs, etc.) on the sides of the plastic surround and if necessary supporting side arms in the very body of the plastic surround. This technique also allows a faster cooling of the moulded part and shorter production cycles, and makes it possible to obtain a particularly satisfactory surface state.

Depending on the plastic material or materials used to form the plastic structure, the retraction may take place by cooling and if necessary by a change of state of the plastic (for example changing to the semi-crystalline state with internal reorganization of the material) and is of a greater or lesser amplitude. The retraction sought is usually at least 0.25% (relative to the width and/or the length) of the surround, and advantageously at least 0.5% and does not exceed 2% (advantageously does not exceed 1.5% or even, depending on the case, 1.2%) of the said width and/or length in order to prevent a visible deformation of the walls and a deterioration or an unattractive appearance of the assembly.

Advantageously, the panel provided with the seal is assembled onto/with the plastic surround after the opening of the mould (or on removal from a press), and preferably out of the mould (after extraction of the surround), preferably before the retraction reaches 40% (and preferably 30%) of the total retraction. In practise, this assembly is often carried out within 10 minutes, and preferably within 4 minutes, of the opening of the mould (and the extraction of the surround, usually simultaneous with the opening of the mould), the plastic being able to continue to retract subsequently for several hours but in a more and more limited manner.

In the event of intermediate processing (such as depositing adhesive) between moulding and assembly, and in order to prevent too great or too rapid a retraction of the plastic, it is possible to have the structure kept at the temperature on removal from the mould or press (for example keeping the structure at a temperature of the order of 60° C. in the case of polypropylene), particularly by providing a temperature-maintaining tunnel on the production line.

### BRIEF DESCRIPTION OF THE DRAWINGS

Other features and advantages of the invention will appear in the following description of non-limiting embodiments of the invention with reference to the appended drawings in which:

FIG. 1 represents a schematic view in perspective of a shelf according to an exemplary embodiment of the invention, showing the top face of the latter in the position of use;

FIG. 2A represents, on a larger scale, a bottom view of the shelf of FIG. 1 and FIG. 2B is a partial bottom view of a variant embodiment;

FIGS. 3A to 3F represent (on a smaller scale) the steps of the method for producing the shelf of FIGS. 1 and 2A;

FIG. 4A represents, again on a larger scale, a view in section on IV-IV of FIG. 2A, FIG. 4B illustrating a variant embodiment, and

FIG. 5 is a partial top view in the direction of the arrow V of FIG. 4A.

### DETAILED DESCRIPTION OF THE PREFERRED EMBODIMENTS

The same types of components are indicated by the same reference numbers from one figure to the other. The shelf is therefore referenced 1 in the figures. In the following description of this part, the words “front”, “rear”, “right”, “left”, “bottom”, “top”, “vertical”, “horizontal” and the equivalent expressions will be used making reference to their position in place in a refrigerator, the user facing the shelf in question.

The shelf 1 includes a mineral or organic glass panel 2, which is rectangular, provided with a frame (surround) 3 made of a relatively rigid plastic, such as polypropylene.

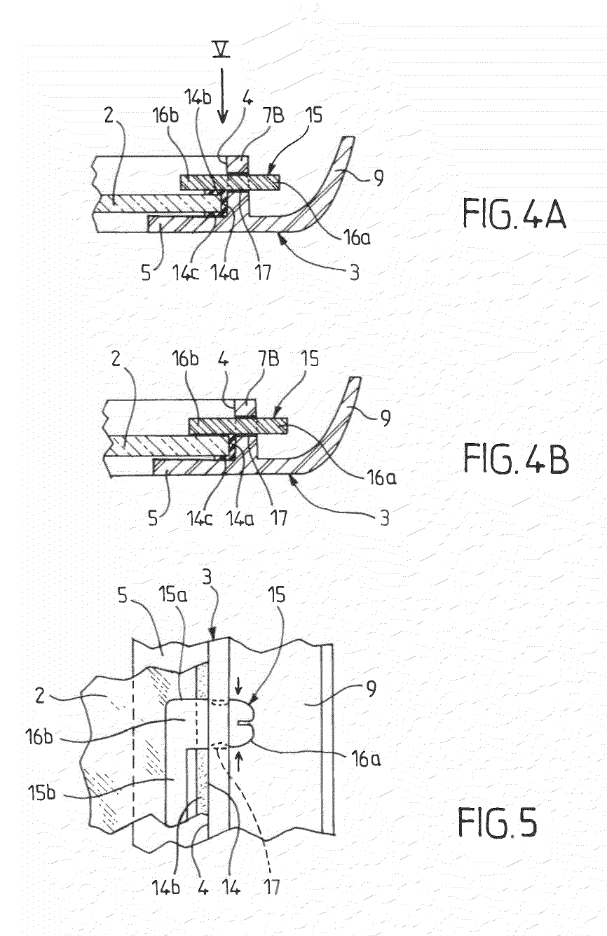

The frame 3, of generally rectangular and flattened shape, comprises an actual surround part, having a vertical inner wall 4 (see FIGS. 4A-5), which is rectangular, that is higher than the thickness of the glass panel 2 and tightly fitting around the latter over the whole of its thickness in the mounted position.

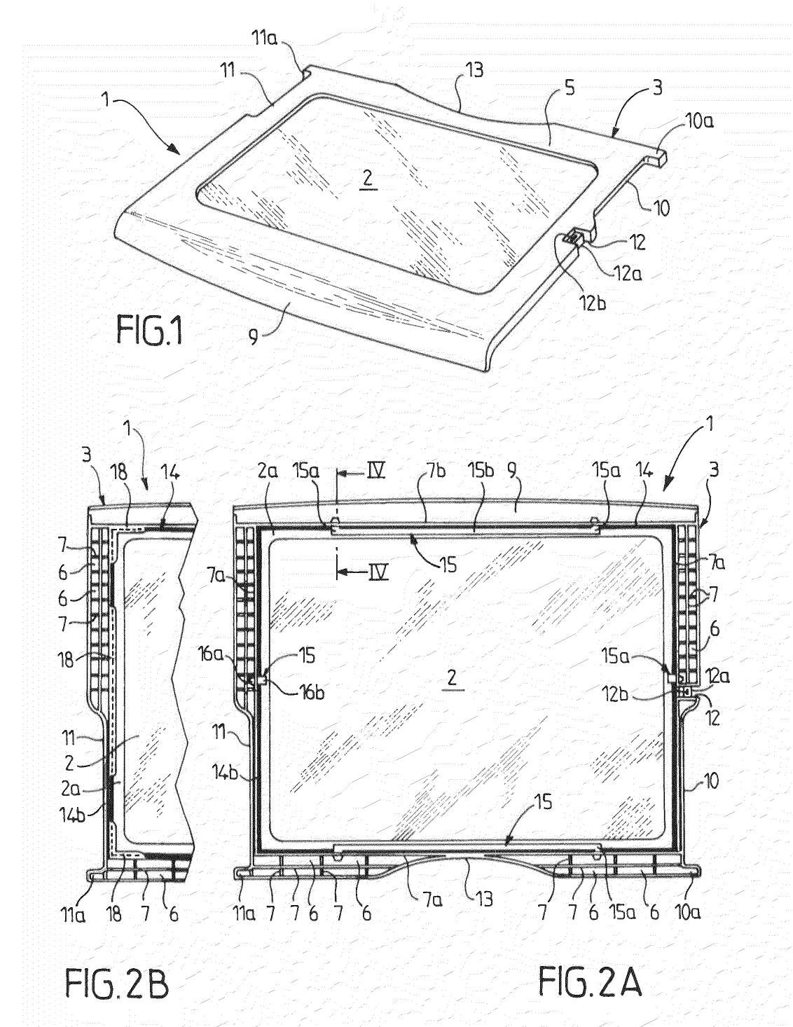

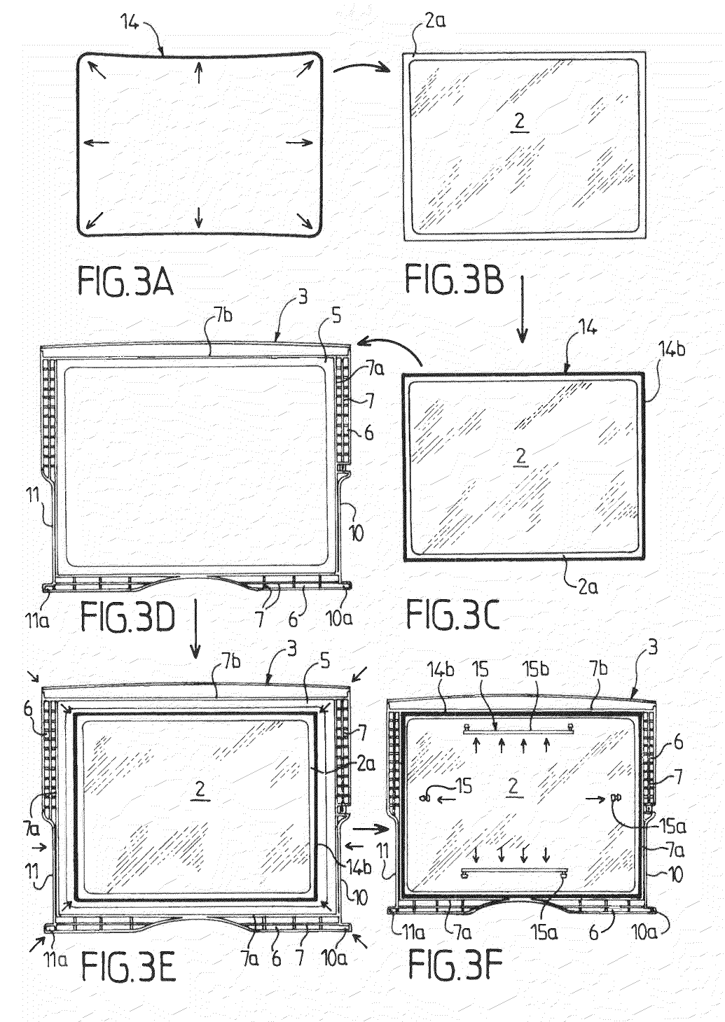

On its top portion, and over the whole of its periphery, the frame 3 forms a rim 5 towards the inside, which applies on the top face of the glass panel 2, its border turned towards the inside forming, for example, a rectangle with rounded corners (FIG. 1). The top face of this rim 5 is in the extension of the top face of the surround 3 in order to form a completely smooth top of the frame 3. The bottom face of the glass panel 2 may be provided with an enamelled border 2a (FIGS. 2 and 3), for example in correspondence with the top rim 5.

The bottom face of the frame 3 is not smooth like the top face, but has, in its rear border regions, right and left, recesses 6 separated by ribs 7, which makes it possible to economize on material in these regions while maintaining sufficient rigidity for the frame 3. These recesses 6 and ribs 7 may be obtained by the technique called “air moulding”.

Such ribs 7 are on the inner border of the rear, right and left regions. In the embodiment shown in FIG. 2A, for example, their inner vertical faces are indistinguishable from the inner border face 4 of the surround of the frame 3 (these peripheral ribs are marked 7a in the drawing and form a frame with a rib 7b of the same type formed along the inner border of the front region of the frame 3).

To complete the description of the shelf 1, it is possible to indicate that:
the frame 3 is, for example, folded downwards at its front portion at 9 in order to form a handle for the manipulation of the shelf 1;
the right and left rims of the shelf 1 have, for example, in the rear region, elongated indentations (respectively) 10 and 11 freeing lugs 10a and 11a on the rear portion of the shelf, the right rim also having, in its central portion, a U-shaped indentation 12, the bottom of which has a rib 12a provided with a central hole 12b ; these cut-outs may, for example, be used, depending on the case, to guide the shelf in rails provided for its support in a refrigerator and/or to prevent it being pulled out once put in place in the refrigerator and/or to engage or add an accessory or complementary element, etc.;
the rear rim of the shelf 1 has a central indentation 13 in an arc of a circle.

The cut-outs of particular shape of the rims of the shelf 1 are most frequently functional (while remaining aesthetic) and depend in particular on the support provided for the shelf (by racks or consoles, method of insertion and withdrawal, etc.). It is particularly routine to provide that, for reasons of safety, the shelf cannot be pulled straight out entirely, being first of all pulled out over only a portion of the latter. Not being a matter for the present invention and only being particular examples, these cut-outs and details will not be described further here.

According to the present invention, an added elastic seal 14 is present between the panel 2 and the plastic surround 3. This seal preferably has a U-shaped section as illustrated in FIG. 4A and therefore straddles (overlaps) the edge of the panel (via its portion 14a or web of the U) and a portion of its bottom rim (by its portion 14b or branch of the U, also visible in FIGS. 2, 3 and 5) and of its top rim (by its portion 14c or second branch of the U). In a variant shown in FIG. 4B, the seal may have an L-shaped cross section (formed by the web 14a and a single branch 14c) so as not to be visible on the underside of the shelf (the branch 14c being, if necessary, hidden on one side by the rim 5 of the surround and on the other by the enamelled border 2a of the panel).

In the embodiment illustrated in FIGS. 2a, 3 and 4, members 15 for retaining the panel 2 at the bottom portion of the latter are provided, these members in this instance being formed, for example, of parts 15a used individually (it is the case of the parts used in this instance on the sides of the shelf—one part per side), or joined together in twos by a rod 15b in a single structure or two-part coupling member 15a in order to make them easier to insert simultaneously (it is the case for the parts used on the front side and rear side of the shelf—two parts joined together in one member on each of these sides). Each portion 15a is formed of an end region 16a that can be deformed under the effect of forces applied laterally (symbolized by arrows in FIG. 5) in order to make it easier to insert into a hole 17 formed in the rib 7a, 7b and by which the hooking of the member is achieved behind the border of the hole 17 after it is inserted into the latter, the opposite region 16b of the maintaining member, which is wider, then pressing in a retentive manner on the panel 2. The portion 16a is then capable of moving from a compressed position for insertion into the hole 17 to a normal position preventing retraction from the hole, the portion 16b, for its part, resting on the panel 2 in order to provide the maintaining thereof (and, if necessary, hiding the portion (of the branch 14b) of the seal present in this location).

In a variant illustrated in FIG. 2B, not using added maintaining members, the maintaining of the panel may be provided in particular by protruding portions (or bearing surfaces) in the form, for example, of tongues 18 forming an integral part of the surround and situated on the bottom face of the surround (these tongues also hiding, if necessary, the portion (of the branch 14b) of the seal present in this location).

The shelf 1 illustrated in particular in FIGS. 1 and 2A is obtained as illustrated in FIG. 3:
the seal 14 is stretched as illustrated by the arrows in FIG. 3A and it is positioned on the edge of the panel 2 (illustrated in FIG. 3B) around the latter, the seal then being released and remaining positioned on the periphery of the panel as illustrated in FIG. 3C;
the surround 3 is placed on a support, coming out of the moulding still in the hot state, via its face comprising the rim 5 (the top face in the position of use), as illustrated in FIG. 3D, and (the assembly formed by) the panel 2 provided with the seal 14 is put in place before the complete retraction of the frame 3, as illustrated in FIG. 3E. The positioning is easy because the frame 3 has no rim on its bottom face;
the frame is allowed to retract. A perfect securing of the assembly is observed, because the panel 2 provided with the seal 14 fits tightly around the frame 3 in an impervious manner;
then the assembly is strengthened for reasons of safety by placing the maintaining members 15 as illustrated by the arrows in FIG. 3F, this placement being, in this case, carried out once the frame 3 has reached its position fitting tightly around the panel provided with the seal. If necessary, the maintaining members may also be welded or bonded. This gives the shelf illustrated in FIGS. 1 and 2A.

It is well understood that the embodiments that have just been described have been given as an indication and are not limiting and that modifications may be made without however departing from the context of the present invention.

The shelf according to the invention is particularly suitable for supporting articles and elements in a refrigerated or refrigerator compartment, and even possibly in other types of furniture items.

1. A shelf for a furniture item, said shelf comprising:
a panel configured to accommodate articles; and
an added plastic surround,
wherein said shelf comprises, between said panel and said surround, at least one added elastic seal.

2. A shelf according to claim 1, wherein the seal is a closed seal.

3. A shelf according to claim 1, wherein the plastic surround also comprises added maintaining members.

4. A method for manufacturing a shelf, said method comprising the following steps:
hot-forming a plastic surround separately from a panel, the panel and the plastic surround being assembled before a complete retraction of the plastic; and
interposing an elastic seal between said panel and said surround before the complete retraction of the plastic.

5. A method according to claim 4, comprising adding maintaining members to the plastic surround after assembly of the panel and of the seal with the surround.

6. A method according to claim 4, comprising stretching and positioning the seal on the edge of the panel around the panel, the seal then being released and remaining positioned on the periphery of the panel;
placing the surround on a support, said surround being in the form of a frame, coming out of the moulding still in the hot state;
inserting the panel provided with the seal into the frame when still in the hot state; and
allowing the frame to retract.

7. A furniture item comprising at least one shelf as in claim 1.

8. A refrigerator comprising a shelf as in claim 1.
